(19) United States
(12) Patent Application Publication
(10) Pub. No.: US 2025/0007788 A1
(43) Pub. Date: Jan. 2, 2025

(54) MULTI-BRANCH NETWORK COLLABORATIVE REASONING METHOD AND SYSTEM FOR INTERNET OF THINGS

(71) Applicant: Tsinghua University, Beijing (CN)

(72) Inventors: Yuezhi Zhou, Beijing (CN); Zhiwei Liang, Beijing (CN)

(73) Assignee: Tsinghua University, Beijing (CN)

(21) Appl. No.: 18/828,885

(22) Filed: Sep. 9, 2024

Related U.S. Application Data
(63) Continuation of application No. PCT/CN2022/104138, filed on Jul. 6, 2022.

(30) Foreign Application Priority Data
May 16, 2022 (CN) 202210526569.6

(51) Int. Cl. H04L 41/147; H04L 67/12

(52) U.S. Cl. CPC H04L 41/147; H04L 67/12

(57) ABSTRACT

A method for cooperative reasoning on a multi-branch network of Internet of Things (IoT) includes: obtaining an initial prediction result and an uncertainty by inputting a sample to be predicted into a first branch of a preset multi-branch network on an IoT device; obtaining an output branch corresponding to the sample in a distribution scheme of the preset multi-branch network based on the uncertainty; and obtaining a final prediction result of the sample by using the output branch based on a model division scheme of the preset multi-branch network, the model division scheme comprising an allocation result of layers of each branch of the multi-branch network on the IoT device and a corresponding server.

### CROSS-REFERENCE TO RELATED APPLICATIONS

This application is a continuation application of International Application No. PCT/CN2022/104138, filed Jul. 6, 2022, which is based upon and claims priority to Chinese Patent Application No. 202210526569.6, filed May 16, 2022, the entire contents of which are incorporated herein by reference.

### TECHNICAL FIELD

The present disclosure belongs to the field of acceleration of a computer vision algorithm of an Internet of things (IoT) device, and particularly relates to a method and system for cooperative reasoning on a multi-branch network of IoT.

### BACKGROUND

With the proliferation of computing and storage devices in areas from server clusters in cloud data centers to personal computers and smart phones, and to wearable devices and other IoT devices, now we have entered an information-centric era where computing is ubiquitous and computing services are gradually transferred from cloud servers to IoT devices. However, the weak computing capability of the existing IoT device makes it difficult to process data generated by the device, so that 1) a large number of computing tasks need to be delivered to a server for processing, which undoubtedly poses a severe challenge to the communication capability of the network and the computing capability of the server; and 2) it is different for the server to meet stringent delay requirements of many new types of applications, such as cooperative autonomous driving and fault detection in smart factories, because the server may be remote from the user.

### SUMMARY

According to a first aspect of embodiments of the present disclosure, there is provided a method for cooperative reasoning on a multi-branch network of Internet of Things (IoT), which includes:
obtaining an initial prediction result and an uncertainty by inputting a sample to be predicted into a first branch of a preset multi-branch network on an IoT device;
obtaining an output branch corresponding to the sample in a distribution scheme of the preset multi-branch network based on the uncertainty; and
obtaining a final prediction result of the sample by using the output branch based on a model division scheme of the preset multi-branch network, the model division scheme including an allocation result of layers of each branch of the multi-branch network on the IoT device and a corresponding server.

In some embodiments of the present disclosure, obtaining the final prediction result of the sample by using the output branch based on the model division scheme of the preset multi-branch network includes:
1) in case that the output branch corresponding to the sample is the first branch, taking the initial prediction result as the final prediction result of the sample;
2) in case that the output branch corresponding to the sample is not the first branch, obtaining the final prediction result by:
2-1) in case that layers in the output branch corresponding to the sample are all allocated to the IoT device, obtaining the final prediction result by using the output branch on the IoT device;
2-2) in case that the layers in the output branch corresponding to the sample are all allocated to the server, obtaining the final prediction result by using the output branch on the server, and returning the final prediction result to the IoT device;
2-3) in case that a part of the layers in the output branch corresponding to the sample is allocated to the IoT device, and a part of the layers in the output branch corresponding to the sample is allocated to the server, obtaining an intermediate result using the part of the layers in the output branch allocated to the IoT device, sending the intermediate result to the server, obtaining the final prediction result using the part of the layers in the output branch allocated to the server according to the intermediate result, and returning the final prediction result to the IoT device.

In some embodiments of the present disclosure, the method further includes:
the initial prediction result including probabilities corresponding to respective prediction categories of the sample output via the first branch, and the uncertainty of the sample being obtained by subtracting a secondary maximum probability value from a maximum probability value.

In some embodiments of the present disclosure, the model division scheme includes a model division point of each branch of the multi-branch network, and the model division point minimizes a reasoning time of the each branch.

In some embodiments of the present disclosure, the method further includes:
in case that the output branch corresponding to the sample is not the first branch, performing continuous calculation on an output result of a backbone part included in the first branch of the multi-branch network using the output branch to obtain the final prediction result.

In some embodiments of the present disclosure, the distribution scheme of the multi-branch network is determined by:
1) determining an uncertainty of each sample in a preset evaluation set by using the multi-branch network, and determining an uncertainty distribution of the evaluation set, the evaluation set including a plurality of samples and classification results corresponding to the plurality of samples;
2) equally dividing all samples in the evaluation set into M groups based on the uncertainty distribution of the evaluation set to obtain a division result of uncertainty levels, where M represents a total number of preset uncertainty levels;
3) determining an initial distribution scheme, a current output branch corresponding to samples of each uncertainty level in the evaluation set in the initial distribution scheme being the first branch of the multi-branch network;
4) taking a current candidate branch corresponding to each uncertainty level as a next branch of the current output branch;
5) determining a speedup ratio corresponding to the current candidate branch for each uncertainty level by using the evaluation set, the speedup ratio being a ratio of a prediction accuracy increase brought about by using the current candidate branch compared to the current output branch to a reasoning time increase brought about by using the current candidate branch compared to the current output branch;
6) selecting an uncertainty level corresponding to a maximum speedup ratio from all current candidate branches, taking the current candidate branch of the uncertainty level as a new current output branch of the uncertainty level, to obtain an updated current distribution scheme; updating the current candidate branch of the uncertainty level to obtain an updated candidate branch set; and
7) repeating steps 5) to 6) until all current candidate branches in the candidate branch set meet a set target requirement, and taking the current distribution scheme as a final distribution scheme of the multi-branch network.

In some embodiments of the present disclosure, the model division scheme is determined by:
1) updating a network bandwidth by using an exponential moving average method with an expression as:

$$Band = ( 1 - α ) * Band + α * B\_runtime$$

where Band represents the network bandwidth, B_runtime represents a real-time network bandwidth, and a represents a hyperparameter, and 0≤α≤1;
2) determining an optimization objective of model division of the multi-branch network:

$$T = {\sum }_{m = 1} ( min {T}_{branch}^{m} ) * {p}_{m}$$

where T represents an average reasoning time of the multi-branch network, T_{branch}^{m} represents a reasoning time of an m^{th} branch, and Pₘ represents a probability that the m^{th} branch is selected;
3) determining the model division point of each branch to obtain the model division scheme of the multi-branch network;
for any branch, the model division point is determined by:
3-1) establishing a directed acyclic graph corresponding to the branch;
taking any branch as an independent deep neural network (DNN) model, and establishing a directed acyclic graph G=(V, E) corresponding to the DNN model; where V represents a set of nodes in the graph G, and each of the nodes is a layer in the DNN model corresponding to the graph G; E represents a set of edges, indicating a set of links of the DNN model corresponding to the graph G, and each of the links reflects a flow direction of data;
taking a link lᵢⱼ=(aᵢ, aⱼ) to represent that an output of a node aᵢ is an input of a node aⱼ, and dᵢ to represent a size of output data of the node aᵢ, then a network transmission time of the link lᵢⱼ=(aᵢ, aⱼ) being

$${t}_{ij}^{n e t} = \frac{{d}_{i}}{Band} ;$$

dividing the set V into two disjoint subsets V_{device} and V_{edge}, where V_{device} represents a subset of nodes executed on the IoT device, and V_{edge} represents a subset of nodes executed on the server; taking L to represent a set of links between the two subsets, i.e., the model division point, a total delay of the cooperative reasoning is a sum of a total execution time T_{device}=Σ_{ν}_{ᵢ}_{∈V}_{_{device}}tᵢ^{device} device of executing the subset V_{device} on the IoT device and a total execution time T_{edge}=Σ_{ν}_{ᵢ}_{∈V}_{_{device}}tᵢ^{device} of executing the subset V_{edge} on the server, where tᵢ^{device} represents an execution time of a layer corresponding to the node aᵢ on the IoT device, and tᵢ^{edge} represents an execution time of the layer corresponding to the node aᵢ on the server; and a sum of a total data transmission data of the model division point L is

$${T}_{net} = \frac{{\sum }_{{l}_{ij} ∈ L} {d}_{i}}{Band} ,$$

then:

$$min {T}_{b r a n c h}^{m} = {T}_{d e v i c e} + {T}_{n e t} + {T}_{edge} ;$$

3-2) adding two virtual nodes d and e in the graph G; where d represents the IoT device, which is a source node; e represents an edge server node, which is a destination node; adding a new edge in the graph G, such that each edge in the graph corresponds to a delay, and the delay includes a network transmission time, an execution time on the IoT device, and an execution time on an edge server; obtaining a new directed acyclic graph Ĝ after a construction is completed; and

3-3) finding a minimum secant between the source node d and the destination node e in the graph G, and taking the minimum secant as the model division point of the branch; taking the minimum secant as a boundary to allocate a node on the same side as the source node in the graph Ĝ to the IoT device, and allocate a node on the same side as the destination node to the server.

According to a second aspect of embodiments of the present disclosure, there is provided an electronic device, which includes: at least one processor; and a memory communicatively connected to the at least one processor and storing instructions executable by the at least one processor. The at least one processor is configured to perform the above-mentioned method for cooperative reasoning on the multi-branch network of IoT.

According to a third aspect of embodiments of the present disclosure, there is provided a non-transitory computer readable storage medium having stored therein computer instructions that, when executed by a processor, cause the processor to perform the above-mentioned method for cooperative reasoning on the multi-branch network of IoT.

### BRIEF DESCRIPTION OF THE DRAWINGS

FIG. 1 is a schematic diagram illustrating a multi-branch network in some embodiments of the present disclosure.

FIG. 2 is an overall flowchart illustrating a method for cooperative reasoning on a multi-branch network of Internet of Things in some embodiments of the present disclosure.

FIG. 3 is a working flowchart illustrating an on-demand adjustment algorithm of a model division scheme in some embodiments of the present disclosure.

FIG. 4 is a schematic diagram illustrating a DNN model in some embodiments of the present disclosure.

FIG. 5 is a schematic diagram illustrating a principle of finding a minimum ST secant in some embodiments of the present disclosure.

### DETAILED DESCRIPTION

With the proliferation of computing and storage devices in areas from server clusters in cloud data centers to personal computers and smart phones, and to wearable devices and other IoT devices, now we have entered an information-centric era where computing is ubiquitous and computing services are gradually transferred from cloud servers to IoT devices. However, the weak computing capability of the existing IoT device makes it difficult to process data generated by the device, so that 1) a large number of computing tasks need to be delivered to a server for processing, which undoubtedly poses a severe challenge to the communication capability of the network and the computing capability of the server; and 2) it is different for the server to meet stringent delay requirements of many new types of applications, such as cooperative autonomous driving and fault detection in smart factories, because the server may be remote from the user. Therefore, how to enable the IoT device to complete the processing of a deep neural network (DNN) model locally is a challenge, which helps to alleviate the pressure caused by data growth.

In order to enable the IoT device to execute a computer vision model, there exists two solutions, including server execution and device execution. In a cloud server-centric solution, data collected on the IoT device is sent to a cloud server via the Internet, a reasoning task is completed using an accelerator on the server, and then the IoT device receives the result returned by the server. However, with the capability of the IoT device increases, the resolution of image data collected by the device becomes higher, and the frame rate of videos also becomes higher. Moreover, in the server-centric solution, the server often needs to process data from multiple devices, and the transmission of raw data may cause great communication and computational pressure on the server and the network. The main idea of edge computation is to migrate the tasks from the cloud server and the IoT device to a server at the edge of the network, which may reduce the impact caused by the fluctuation of the Internet, relieve the pressure on the Internet, and make the device respond to the image processing requirements in real-time. However, edge computation is still affected by the fluctuation of the network, and the deterioration of the network will seriously affect the unloading of the reasoning task.

Currently, the deployment process of the DNN model on the IoT device includes the maintenance of two models, one is a large-scale high-precision model on the server, and the other is a small-scale low-precision model on the device. However, this approach incurs significant deployment overhead. First, from a perspective of development time, the dual-model approach needs to train two models, resulting in two time- and resource-intensive stages. In the first phase, the design and training of the large-scale model requires multiple GPUs to run for long periods of time. In the second stage, the large-scale model is compressed by various techniques to obtain a corresponding lightweight model, and selecting and adjusting the compression method itself is a difficult task. Furthermore, in order to recover the lost accuracy due to the compression, the lightweight model must be fine-tuned by some additional training step.

Compared with the device execution and server execution, cooperative reasoning may realize a low-delay reasoning task, but is still difficult to meet real-time requirements in some scenarios, and cannot adapt to dynamic changes in throughput. The reason is that the efficiency of the cooperative reasoning is highly dependent on the available bandwidth between the server and the IoT device. Since the communication delay takes up most of the entire reasoning time, it may have catastrophic consequence when the network is unavailable. In some traffic flow monitoring systems, the number of vehicles is correlated with the time, and the flow of vehicles in morning and evening peaks is far larger than that in late night, which means that data to be processed by the device changes over the time, and the IoT device is required to process the data in real time.

An object of the present disclosure is to overcome the deficiencies in the related art and provide a method and system for cooperative reasoning on a multi-branch network of Internet of Things (IoT). The present disclosure may realize the adjustment of the cooperative reasoning on the multi-branch network on demand, solve the challenge of distributed multi-branch network reasoning across a device and a server, and ensure the IoT device to provide a service stably in a highly dynamic environment.

Embodiments of the present disclosure provide a method and system for cooperative reasoning on a multi-branch network of Internet of Things (IoT), which will be further described in detail below in conjunction with the accompanying drawings and specific embodiments.

According to embodiments of the present disclosure, there is provided a method for cooperative reasoning on a multi-branch network of IoT, which includes:
obtaining an initial prediction result and an uncertainty by inputting a sample to be predicted into a first branch of a preset multi-branch network on an IoT device;
obtaining an output branch corresponding to the sample in a distribution scheme of the preset multi-branch network based on the uncertainty; and
obtaining a final prediction result of the sample by using the output branch based on a model division scheme of the preset multi-branch network, the model division scheme including an allocation result of layers of each branch of the multi-branch network on the IoT device and a corresponding server.

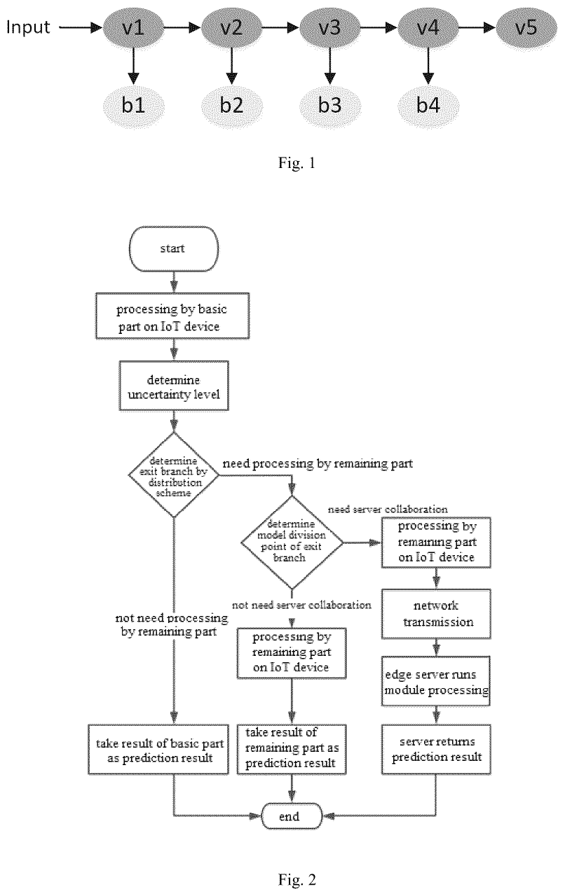

In some embodiments of the present disclosure, the multi-branch network has a structure as shown in FIG. 1, a backbone part of the multi-branch network includes 5 layers connected in sequence, nodes v₁, v₂, v₃, v₄ and v₅ represent various layers of the backbone part of the multi-branch network, respectively, nodes b₁, b₂, b₃ and b₄ represent branches extending from the layers v₁, v₂, v₃ and v₄, respectively, a solid line represents a flow process of data, and nodes (v₁, b₁) constitute a first branch of the multi-branch network, namely, a basic part of the multi-branch network. The rest of the branches constitute the rest of the multi-branch network, including: a second branch constituted by nodes (v₁, v₂, b₂), a third branch constituted by nodes (v₁, v₂, v₃, b₃), a fourth branch constituted by nodes (v₁, v₂, v₃, v₄, b₄), and a fifth branch constituted by nodes (v₁, v₂, v₃, v₄, Vs).

According to embodiments of the present disclosure, there is provided a method for cooperative reasoning on the multi-branch network of IoT, and the overall process is as shown in FIG. 2, including a following step:

1) obtaining an initial prediction result and an uncertainty by inputting a sample to be predicted into a first branch of a preset multi-branch network, where the first branch is deployed on an IoT device.

In some embodiments of the present disclosure, the sample to be predicted includes: a picture or a video frame used to perform a task such as image classification or target detection.

In some embodiments of the present disclosure, the initial prediction result includes probabilities corresponding to respective prediction categories of the sample output via the first branch, and the uncertainty of the sample is obtained by subtracting a secondary maximum probability value from a maximum probability value.

The method includes:

2) obtaining an output branch corresponding to the sample to be predicted in a distribution scheme of the preset multi-branch network based on the uncertainty.

The distribution scheme of the multi-branch network is to determine an output branch corresponding to each uncertainty level, and the output branch may be the first branch, in other words, the remaining branches are no longer used. In some embodiments of the present disclosure, in case that the output branch is the first branch, a prediction result of the branch b₁ is taken directly as a final classification result of the input sample.

The distribution scheme of the multi-branch network is determined after the training of the multi-branch network is completed, and in some embodiments of the present disclosure, the distribution scheme of the multi-branch network is specifically determined as follows.

2-1) an uncertainty of each sample in a preset evaluation set is determined by using the multi-branch network, and an uncertainty distribution of the evaluation set is determined.

The evaluation set includes a plurality of samples and classification results corresponding to the plurality of samples.

Specifically, an initial uncertainty distribution for all samples of the evaluation set is determined using an initial prediction result of the evaluation set obtained through the first branch of the multi-branch network (i.e. the branch closest to the input of the multi-branch network, which is the branch b₁ in embodiments of the present disclosure).

In some embodiments of the present disclosure, for any sample of the evaluation set, it is assumed that an output of the branch b₁ is y=(y₁, y₂, . . . , y₁₀)), where yᵢ represents a probability that the predicted sample is class i. Then, the probability ŷᵢ for each category finally output is:

$${{y}^{⌢}}_{i} = Temperature Scalings ( Z , T ) = \frac{{e}^{\frac{{y}_{i}}{T}}}{{\sum }_{j = 1}^{10} {e}^{\frac{{y}_{j}}{T}}}$$

where T represents a hyperparameter, which may be determined by a heuristic method, such that the uncertainty distribution is close to a uniform distribution. In some embodiments of the present disclosure, T=1.5.

The uncertainty of the sample is determined by the final output ŷ=(ŷ₁, ŷ₂, . . . , ŷ₁₀), and the expression is as follows:

$$U ( {y}^{⌢} ) = Top 1 ( {y}^{⌢} ) - Top 2 ( {y}^{⌢} ) .$$

That is, the uncertainty of the sample is obtained by subtracting a secondary maximum value Top 2(ŷ) in ý from a maximum value Top 1(ŷ) in ŷ.

2-2) Division of uncertainty levels.

Based on the uncertainty distribution obtained from the step 2-1), the samples in the evaluation set are evenly divided into M shares based on the uncertainty of each sample in the evaluation set, so as to determine M uncertainty levels, where M is an adjustable parameter, the greater M is, the finer the division of the uncertainty is, but the calculation will be more complicated, and the number of samples in the evaluation set is also required to be higher.

In some embodiments of the present disclosure, M=10, and classification boundaries for different levels are [0.000, 0.058, 0.130, 0.223, 0.343, 0.480, 0.625, 0.777, 0.894, 0.966, 1]. Samples with an uncertainty close to 0 are difficult samples, and samples with an uncertainty close to 1 are simple samples. Then the evaluation set is divided into 10 sample groups based on the classification boundaries, and a precision and a reasoning delay at each branch are tested for sample groups with different uncertainty levels, where the precision is an average prediction accuracy of each sample group output by each branch, and the reasoning delay is an average execution time of each sample group output by each branch.

2-3) Initialization of the distribution scheme.

Based on the uncertainty level division result, samples of all uncertainty levels in the evaluation set are initially output from the first branch. In some embodiments of the present disclosure, an initial distribution scheme is [1, 1, 1, 1, 1, 1, 1, 1, 1, 1], that is, the samples in the evaluation set divided into 10 uncertainty levels all select the branch b₁ to output respective picture prediction results.

A next branch of a current output branch is taken as a current candidate branch corresponding to each uncertainty level. In some embodiments of the present disclosure, an initial candidate branch for each uncertainty level is the branch b₂, and an initial candidate branch set is [2, 2, 2, 2, 2, 2, 2, 2, 2, 2].

A speedup ratio corresponding to the current candidate branch is determined for each uncertainty level. The speedup ratio is a ratio of an accuracy increase brought about by using the current candidate branch compared to the current output branch to a reasoning time increase brought about by using the current candidate branch compared to the current output branch, with an expression as follows:

$$\frac{{Δ}_{a c c}}{{Δ}_{t i m e}}$$

where Δ_{acc}=NewBranch_{acc}−OldBranch_{acc}, representing a prediction accuracy increase brought about by using the current candidate branch to replace the current output branch; NewBranch_{acc} represents a prediction accuracy corresponding to the current candidate branch, and OldBranch_{acc} represents a prediction accuracy corresponding to the current output branch;
Δₜᵢₘₑ=NewBranchₜᵢₘₑ−OldBranchₜᵢₘₑ, representing a reasoning time increase brought about by using the current candidate branch to replace the current output branch; NewBranchₜᵢₘₑ represents a reasoning time corresponding to the current candidate branch, and OldBranchₜᵢₘₑ represents a reasoning time corresponding to the current output branch.

2-4) Update of the distribution scheme.

An uncertainty level corresponding to a maximum speedup ratio is selected from all current candidate branches, and the current candidate branch of this uncertainty level is taken as a new current output branch of this uncertainty level, to obtain an updated current distribution scheme; and then the candidate branch of this uncertainty level is updated as a next branch of the current output branch to obtain an updated candidate branch set. An updated speedup for each uncertainty level is determined by using the updated current distribution scheme and the updated candidate branch set.

In some embodiments of the present disclosure, in case that a candidate branch with a largest speedup ratio after the first update corresponds to a first uncertainty level, the current distribution scheme is updated to [2, 1, 1, 1, 1, 1, 1, 1, 1, 1], and the candidate branch set is updated to [3, 2, 2, 2, 2, 2, 2, 2, 2, 2]. A speedup ratio of the candidate branch corresponding to the first uncertainty level is updated as a ratio of an accuracy increase to a reasoning delay increase of the sample of the first uncertainty level brought about by the branch 3 compared to the branch 2.

2-5) A final output branch corresponding to each uncertainty level is obtained by using a distribution scheme generation algorithm (DSGA) to form a final distribution scheme of the multi-branch network.

It should be noted that the core concept of the DSGA algorithm provided in embodiments of the present disclosure is to greedily select the candidate branch with the maximum speedup ratio every time the current distribution scheme is updated, until all current candidate branches in the candidate branch set do not bring about an accuracy improvement or the current distribution scheme has met a target accuracy.

It should be noted that the multi-branch network speeds up the reasoning process by inserting an auxiliary classifier in a shallow layer of the model, which may improve the experience of running a DNN model on the IoT device. Combination of the model partition with the multi-branch network may achieve a trade-off between the communication and the computation, but the particularity of the multi-branch network makes the model partition more difficult than traditional model partition. In the multi-branch network, the execution of the sample depends on the uncertainty of the sample. A simple sample may exit at the first branch, while a difficult sample needs to exit at a deep branch. In the reasoning process of the multi-branch network, the uncertainty and initial prediction information of the input sample are determined by the first branch. The subsequent output branches are then determined by the distribution scheme of the multi-branch network. For example, a sample may be output at the third branch, or may exit at the fifth branch. The accuracy of the deep branch is higher than that of a shallow branch. By adjusting the distribution scheme of the multi-branch network, multi-branch networks with different average reasoning delay and accuracy may be obtained.

Furthermore, according to embodiments of the present disclosure, the distribution scheme of the multi-branch network may also be dynamically adjusted based on a target requirement (such as an accuracy requirement or a throughput requirement), current load levels of the IoT device and server, and a size of the current network bandwidth. That is, different target requirements may be met by adjusting a proportion of samples output at different branches to the total samples.

3) The final prediction result of the sample to be predicted is obtained by using the output branch based on the distribution scheme of the multi-branch network and the model division scheme.

In some embodiments of the present disclosure, the specific steps are as follows:

3-1) obtaining the model division scheme of the multi-branch network, where the model division scheme includes a hierarchical processing allocation result of branches of the multi-branch network on the IoT device and the edge server.

3-2) obtaining the final prediction result of the sample to be predicted by using the model division scheme based on the output branch corresponding to the sample to be predicted. The specific steps are as follows.

3-2-1) In case that the output branch corresponding to the sample is the first branch, the sample does not need to be processed further, and the initial prediction result obtained in the step 1) is taken as the final prediction result of the sample, and is directly output by the IoT device.

3-2-2) In case that the output branch corresponding to the sample is not the first branch, the prediction result of the first branch is no longer used, and the prediction result of the sample is obtained from the output branch corresponding to the sample based on the model division scheme. In the subsequent processing, the result from the node v₁ in the first branch in the step 1) may be directly used for subsequent processing to improve the calculation efficiency.

In some embodiments of the present disclosure, the processing method is as follows.

3-2-2-1) In case that in the model division scheme, all layers of the output branch corresponding to the sample are allocated to the IoT device to process, the final prediction result of the sample is directly determined by using the corresponding branch on the IoT device.

In some embodiments of the present disclosure, for example, a model division point corresponding to the branch 2 is located after the last layer of the branch, that is, all layers of this branch are allocated to the IoT device, then on the IoT device, the final prediction result of the input image is obtained by continuously reasoning on the output of the node v₁ through the nodes v₂ and b₂.

3-2-2-2) In case that in the model division scheme, all layers in the output branch corresponding to the sample are allocated to the edge server, the final prediction result of the sample is determined by the edge server using the corresponding branch, where the input of the edge server is the output result of the backbone part of the multi-branch network included in the first branch.

In some embodiments of the present disclosure, for example, a model division point corresponding to the branch 5 is located after the last layer of the branch, that is, all layers of this branch are allocated to the edge server, and all unprocessed layers need to be executed on the edge server to complete the reasoning task. In this case, the result of the node v₁ may be reused, so the node v₁ does not need to be executed again on the server, and the output of the node v₁ is sent to the edge server via wifi. The nodes (v₂, v₃, v₄, Vs) are used to continue the reasoning, and the final prediction result of the input image is returned to the IoT device via wifi.

3-2-2-3) In case that in the model division scheme, a part of the output branch corresponding to the sample is allocated to the IoT device, and a part of the output branch corresponding to the sample is allocated to the edge server, an intermediate result is obtained through the part of the output branch allocated to the IoT device and sent to the edge server, and then the final prediction result of the sample is obtained through the part of the output branch allocated to the edge server and returned to the IoT device. An input of the part of the output branch allocated to the IoT device is an output result of the backbone part of the multi-branch network included in the first branch.

In some embodiments of the present disclosure, for example, a model division point corresponding to the fourth branch is located between the nodes v₂ and v₃. In this case, the output of the node v₁ is first processed by the node v₂ deployed on the IoT device, then the output of the node v₂ is sent to the edge server via the wifi, and the nodes (v₃, v₄, b₄) are used to continue the reasoning to obtain the final prediction result of the input image, and then the final prediction result is returned to the IoT device via the wifi.

Furthermore, the model division scheme of the multi-branch network is implemented as follows.

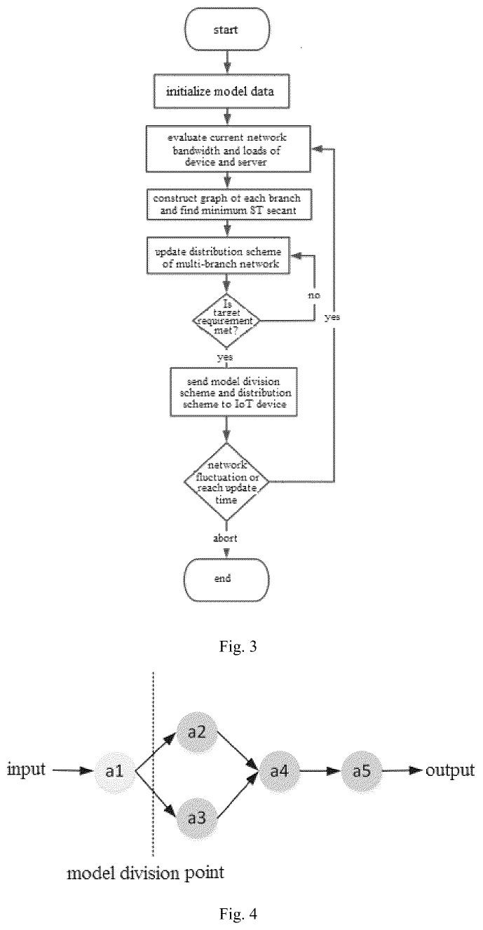

In some embodiments of the present disclosure, considering the fluctuation of the network bandwidth and the fluctuation of loads of the IoT device and edge server in the cooperative reasoning process, an on-demand adjustment algorithm of the model division scheme is provided. The overall flow is shown in FIG. 3. The on-demand adjustment algorithm runs once every fixed period or when the network fluctuation is detected, and the specific steps are as follows.

3-1-1) The network bandwidth is updated by using an exponential moving average (EMA) method, with an expression as follows:

$$Band = ( 1 - α ) * Band + α * B\_runtime$$

where Band represents the network bandwidth used to determine a network transmission time, B_runtime represents a real-time network bandwidth, and a represents a hyperparameter set by the EMA method, and 0≤a≤1. In some embodiments of the present disclosure, a=0.1.

3-1-2) An optimization objective is determined for model division of the multi-branch network:

$$T = {\sum }_{m = 1} ( min {T}_{branch}^{m} ) * {p}_{m} ,$$

where T represents an average reasoning time of the multi-branch network, T_{branch}^{m} represents a reasoning time of an m^{th} branch, and Pₘ represents a probability that the m^{th} branch is selected. In embodiments of the present disclosure, the optimization objective separately considers an optimal model division point of each branch, and eliminates the influence of the probability that the branch is selected.

3-1-3) The model division point of each branch is determined to obtain the model division scheme of the multi-branch network.

In embodiments of the present disclosure, for any branch, the model division point is determined as follows.

3-1-3-1) A directed acyclic graph corresponding to the branch is established.

It should be noted that in embodiments of the present disclosure, any of the branches may be regarded as a separate DNN model, so the model division method in embodiments of the present disclosure is also applicable to the traditional DNN model. In some embodiments of the present disclosure, the multi-branch network shown in FIG. 4 is taken as an example to describe a model division method for the DNN model.

Any branch sub-network is taken as an independent DNN model, and a directed acyclic graph (DAG) corresponding to the DNN model is established, G=(V, E). In embodiments of the present disclosure, V=(a₁, a₂, a₃, a₄, a₅), representing a set of nodes in the graph G, and each of the nodes is a layer in the DNN model corresponding to the graph G; E represents a set of edges, indicating a set of links of the DNN model corresponding to the graph G, each of the edges reflects a flow direction of data, and any link lᵢⱼ=(aᵢ, aⱼ) represents that an output of a node aᵢ is an input of a node aⱼ. Moreover, a network transmission time of the link lᵢⱼ=(aᵢ, aⱼ) is

$${t}_{ij}^{net} = \frac{{d}_{i}}{Band} ,$$

where dᵢ represents a size of output data of the node aᵢ, and Band represents the size of network bandwidth.

Model division needs to divide the nodes in the graph G into two disjoint subsets V_{device} and V_{edge}, their sum is V, where V_{device} represents a subset of nodes executed on the IoT device, V_{edge} represents a subset of nodes executed on the server; and L represents a set of links between the two subsets, i.e. the model division point (as shown by a dotted line in FIG. 7). A total execution time of executing the subset V_{device} on the device is T_{device}=Σ_{ν}_{ᵢ}_{∈V}_{_{device}}tᵢ^{device}, where tᵢ^{device} represents an execution time of a layer aᵢ on the IoT device. A total execution time of executing the subset V_{edge} on the edge server is T_{edge}=Σ_{ν}_{ᵢ}_{∈V}_{_{edge}}tᵢ^{edge}, where tᵢ^{edge} represents an execution time of the layer aᵢ on the edge server. A sum of a total data transmission time of the model division point L is

$${T}_{net} = \frac{{\sum }_{{l}_{ij} ∈ L} {d}_{i}}{Band} .$$

A total delay of the cooperative reasoning is a sum of T_{device}, T_{edge} and Tₙₑₜ. The optimization objective for any branch sub-network is: min T_{branch}^{m}=T_{device}+Tₙₑₜ+T_{edge}.

3-1-3-2) A new graph Ĝ is constructed based on the original graph G.

In embodiments of the present disclosure, the problem of network division is transformed into an equivalent problem of finding a minimum secant ST of the DAG graph. The new graph Ĝ is constructed based on the original graph G, each edge in the new graph corresponds to a delay in step 3-1-3-1), and the delay includes the data transmission time, the execution time on the IoT device, and the execution time on the edge server in step 3-1-3-1).

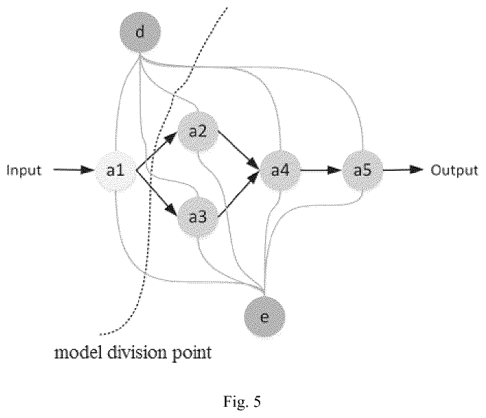

In some embodiments of the present disclosure, as shown in FIG. 5, two virtual nodes d and e are added to the graph G, where d represents the IoT device and is a source node; and e represents the edge server and is a destination node. The minimum secant of the graph Ĝ is to find such a division point (the dotted line in FIG. 5) between the node d and the node e that minimizes a sum of weights of links connected with the dotted line. Links between the nodes in the original graph G and the virtual nodes are used to represent the execution time of the layer on the IoT device and the edge server. It is worth noting that a line connected to the node e represents an execution time of a corresponding layer of this node in the graph G on the IoT device, for example, a weight of a link l₁ₑ=(a₁, e) is an execution time t₁^{device} of the node a₁ on the IoT device.

However, for some nodes, there are multiple successor nodes. For example, following the node a₁, there are two nodes a₂ and a₃, which will cause double calculation of the communication delay. Based on the division method shown in FIG. 5, the output data of the node a₁ actually only needs to be transmitted once, so the communication delay should only be calculated once. In view of this, in embodiments of the present disclosure, a weight of a corresponding link is updated to one-half of an out-degree of a communication delay of a forward node. For example, the out-degree of the node a₁ is 2, and the weight of links l₁₂=(a₁, a₂) and l₁₃=(a₁, a₃) with the node a₁ as the forward node is

$$\frac{{d}_{1}}{2 * Band} .$$

The update is based on a fact that all links with the same forward node, rather than some of the links with the same forward node, will be connected to the dotted line of the division point at the same time. Assuming that nodes a₁ and a₃ are executed on the device, output data of the node a₁ still needs to be transmitted to the server, so the weight corresponding to the link l₁₂=(a₁, a₂) will not match, but this case is impossible to occur, because the reasoning will be faster when the node a₃ is placed on the server at this time, as the speed that the server processes the node is significantly faster than the IoT device, which means that once data of a node is sent to the server, all its successor nodes are executed on the server, and the reasoning time is shorter.

3-1-3-3) A minimum secant between the source node d and the destination node e in the new graph Ĝ is found, and the minimum secant corresponds to the model division point. Taking the secant as a boundary, DNN model node(s) on the same side as the source node in the graph Ĝ is/are allocated to the IoT device to perform calculation, and DNN model node(s) on the same side as the destination node is/are allocated to the server to perform calculation.

It should be noted that the model division is to divide the model into two parts, one part is deployed on the IoT device, and the other part is deployed on the server. In the model division scheme, the time of once reasoning consists of a computation time and a communication time. The communication time is related to the size of the transmitted data and the network bandwidth, and output data of a middle layer of the DNN model is generally less than the original data, that is, the communication delay caused by sending data from the middle layer is less than the delay caused by sending the original data. Another advantage brought by the execution of some layers by the device is to reduce the pressure on the server, such that the server may serve more IoT devices. Model division may also solve the problem of privacy leakage. Sending the original data directly may easily cause privacy leakage, while the intermediate data has been encrypted once after processed by the model, which reduces the possibility of information leakage during the network transmission.

The distribution scheme of the multi-branch network is obtained after determining the model division points for all branches.

Furthermore, embodiments of the present disclosure also include the following operations.

2) 3-1-4) The distribution scheme of the multi-branch network is updated based on the target requirement.

The cooperative reasoning time of each branch in the multi-branch network is estimated, and then the distribution scheme of the multi-branch network is updated. According to actual application scenarios, there are two target requirements, i.e. the throughput requirement and the accuracy requirement. The accuracy requirement requires that the accuracy of the multi-branch network is not less than the target requirement, and the throughput requirement requires that the multi-branch network is able to process a certain number of samples within a specified time. A deep branch in the multi-branch network has a longer reasoning time than a shallow branch, but the corresponding accuracy is higher.

3-1-4-1) In case that the current target requirement is the accuracy requirement, but the accuracy of the current distribution scheme is lower than the target accuracy requirement, the distribution scheme of the multi-branch network is updated to increase a proportion of samples output in deep branches to all samples.

3-1-4-2) In case that the current target requirement is the accuracy requirement, but the accuracy of the current distribution scheme is higher than the target requirement, the distribution scheme of the multi-branch network is updated to increase a proportion of samples output in shallow branches to all samples to provide a faster reasoning scheme, but the accuracy requirement needs to be guaranteed.

3-1-4-3) In case that the current target requirement is the throughput requirement, but the average reasoning time of the current distribution scheme is greater than the target requirement, the distribution scheme of the multi-branch network is updated to increase a proportion of samples output in shallow branches to all samples.

3-1-4-4) In case that the current target requirement is the throughput requirement, but the average reasoning time of the current distribution scheme is less than the target requirement, the distribution scheme of the multi-branch network is updated to increase a proportion of samples output in deep branches to all samples to provide a faster reasoning scheme, but the throughput requirement needs to be guaranteed.

According to embodiments of the present disclosure, there is provided a system for cooperative reasoning on the multi-branch network of internet of things (IoT), which includes: an initial prediction module, an output branch determining module, and a cooperative reasoning module.

The initial prediction module is arranged on an IoT device, and configured to input a sample to be predicted into a first branch of a preset multi-branch network to obtain an initial prediction result and an uncertainty.

The output branch determining module is configured to obtain an output branch corresponding to the sample in a distribution scheme of the preset multi-branch network based on the uncertainty.

The cooperative reasoning module is configured to obtain a final prediction result of the sample by using the output branch based on a model division scheme of the preset multi-branch network. The model division scheme includes an allocation result of layers of each branch of the multi-branch network on the IoT device and a corresponding server.

According to embodiments of the present disclosure, there is provided an electronic device, which includes: at least one processor; and a memory communicatively connected to the at least one processor. The memory stores instructions executable by the at least one processor, and the instructions are configured to perform the above-mentioned method for cooperative reasoning on the multi-branch network of IoT.

According to embodiments of the present disclosure, there is provided a non-transitory computer readable storage medium having stored therein computer instructions that, when executed by a processor, cause the processor to perform the above-mentioned method for cooperative reasoning on the multi-branch network of IoT.

The features and advantageous effect of the present disclosure are as follows.

1) The present disclosure solves the challenge of distributed multi-branch network reasoning across a device and a server, which may support complex performance goals in a highly dynamic environment while ensuring that the IoT device provides services stably.

2) The present disclosure solves the problem of model division of the multi-branch network, and optimizes a unified model division scheme of the multi-branch network to find a model division scheme of a single branch, resulting in a more reasonable model division scheme.

3) The present disclosure proposes an adaptive adjusting method based on a target requirement and the change in network bandwidth, in which the model division scheme and the distribution scheme of the multi-branch network may be adaptively adjusted based on a current state to enhance a service experience of the IoT device to maintain its performance in an edge computing environment. The present disclosure may determine an optimal cooperative reasoning scheme based on the network bandwidth condition in real-time without consuming excessive computational resources.

It should be noted that the computer readable medium mentioned in the present disclosure above may be a computer-readable signal medium, a computer-readable storage medium, or any combination thereof. The computer-readable storage medium may include, but is not limited to, an electronic, magnetic, optical, electromagnetic, infrared or semiconductor system, apparatus or device or any combination of the foregoing. More specific examples of the machine-readable storage medium may include, but is not limited to, electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combination of the foregoing.

In the context of the present disclosure, the computer readable storage medium may be any tangible medium including or storing programs. The programs may be used by or in conjunction with an instruction executed system, apparatus or device. In the present disclosure, the computer readable signal medium may include a data signal propagating in a baseband or as a part of a carrier which carries computer readable program codes. Such propagated data signal may be in many forms, including but not limited to an electromagnetic signal, an optical signal, or any suitable combination thereof. The computer readable signal medium may also be any computer readable medium other than the computer readable storage medium, which may send, propagate, or transport programs used by or in conjunction with an instruction executed system, apparatus or device. The program code stored on the computer readable medium may be transmitted using any appropriate medium, including but not limited to an electric wire, an optical fiber cable, radio frequency (RF), or any suitable combination thereof.

The above computer readable medium may be contained in the electronic device; it may also be present separately and not fitted into the electronic device. The computer readable medium carries one or more programs that, when executed by the electronic device, cause the electronic device to perform the method for cooperative reasoning on the multi-branch network of Internet of Things as described in the above embodiments.

The computer program code for carrying out operations of embodiments of the present disclosure may be written in one or more programming languages or a combination thereof. The programming language includes an object oriented programming language, such as Java, Smalltalk, C++, as well as conventional procedural programming language, such as “C” language or similar programming language. The program code may be executed entirely on a user's computer, partly on the user's computer, as a separate software package, partly on the user's computer, partly on a remote computer, or entirely on the remote computer or server. In a case of the remote computer, the remote computer may be connected to the user's computer or an external computer (such as using an Internet service provider to connect over the Internet) through any kind of network, including a Local Area Network (LAN) or a Wide Area Network (WAN).

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples. In addition, in the absence of contradiction, those skilled in the art can combine different embodiments or examples described in this specification, or combine the features of different embodiments or examples.

In addition, terms such as “first” and “second” are used herein for purposes of description and are not intended to indicate or imply relative importance or significance or imply the number of the indicated technical features. Thus, the feature defined with “first” and “second” may comprise one or more this feature. In the description of the present disclosure, the phrase of “a plurality of” means two or more than two, for example, two or three, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, in which the order of execution is different from what is shown or discussed, including executing functions in a substantially simultaneous manner or in an opposite order according to the related functions. These and other aspects should be understood by those skilled in the art.

The logic and/or step shown in the flow chart or described in other manners herein, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It can be understood by those skilled in the art that all or part of the steps in the method of the above embodiments can be implemented by instructing related hardware via programs, the program may be stored in a computer readable storage medium, and the program includes one step or combinations of the steps of the method embodiment when the program is executed.

In addition, each functional unit in embodiments of the present disclosure may be integrated in one progressing module, or each functional unit exists as an independent unit, or two or more functional units may be integrated in one module. The integrated module can be embodied in hardware or software functional module. If the integrated module is embodied in software functional module and sold or used as an independent product, it can be stored in the computer readable storage medium.

The above storage medium may be, but is not limited to, read-only memories, magnetic disks, or optical disks. Although explanatory embodiments have been shown and described above, it would be appreciated by those skilled in the art that the above embodiments are illustrative, and cannot be construed to limit the present disclosure, and changes, alternatives, variants and modifications can be made in the embodiments without departing from the scope of the present disclosure.

What is claimed is:

1. A method for cooperative reasoning on a multi-branch network of internet of things (IoT), comprising:
obtaining an initial prediction result and an uncertainty by inputting a sample to be predicted into a first branch of a preset multi-branch network on an IoT device;
obtaining an output branch corresponding to the sample in a distribution scheme of the preset multi-branch network based on the uncertainty; and
obtaining a final prediction result of the sample by using the output branch based on a model division scheme of the preset multi-branch network, the model division scheme comprising an allocation result of layers of each branch of the multi-branch network on the IoT device and a corresponding server.

2. The method of claim 1, wherein obtaining the final prediction result of the sample by using the output branch based on the model division scheme of the preset multi-branch network comprises:
1) in case that the output branch corresponding to the sample is the first branch, taking the initial prediction result as the final prediction result of the sample;
2) in case that the output branch corresponding to the sample is not the first branch, obtaining the final prediction result by:
2-1) in case that layers in the output branch corresponding to the sample are all allocated to the IoT device, obtaining the final prediction result by using the output branch on the IoT device;
2-2) in case that the layers in the output branch corresponding to the sample are all allocated to the server, obtaining the final prediction result by using the output branch on the server, and returning the final prediction result to the IoT device;
2-3) in case that a part of the layers in the output branch corresponding to the sample is allocated to the IoT device, and a part of the layers in the output branch corresponding to the sample is allocated to the server, obtaining an intermediate result using the part of the layers in the output branch allocated to the IoT device, sending the intermediate result to the server, obtaining the final prediction result using the part of the layers in the output branch allocated to the server according to the intermediate result, and returning the final prediction result to the IoT device.

3. The method of claim 1, further comprising:
the initial prediction result comprising probabilities corresponding to respective prediction categories of the sample output via the first branch, and the uncertainty of the sample being obtained by subtracting a secondary maximum probability value from a maximum probability value.

4. The method of claim 1, wherein the model division scheme comprises a model division point of each branch of the multi-branch network, and the model division point minimizes a reasoning time of the each branch.

5. The method of claim 2, further comprising:
in case that the output branch corresponding to the sample is not the first branch, performing continuous calculation on an output result of a backbone part comprised in the first branch of the multi-branch network using the output branch to obtain the final prediction result.

6. The method of claim 1, wherein the distribution scheme of the multi-branch network is determined by:
1) determining an uncertainty of each sample in a preset evaluation set by using the multi-branch network, and determining an uncertainty distribution of the evaluation set, the evaluation set comprising a plurality of samples and classification results corresponding to the plurality of samples;
2) equally dividing all samples in the evaluation set into M groups based on the uncertainty distribution of the evaluation set to obtain a division result of uncertainty levels, wherein M represents a total number of preset uncertainty levels;
3) determining an initial distribution scheme, a current output branch corresponding to samples of each uncertainty level in the evaluation set in the initial distribution scheme being the first branch of the multi-branch network;
4) taking a current candidate branch corresponding to each uncertainty level as a next branch of the current output branch;
5) determining a speedup ratio corresponding to the current candidate branch for each uncertainty level by using the evaluation set, the speedup ratio being a ratio of a prediction accuracy increase brought about by using the current candidate branch compared to the current output branch to a reasoning time increase brought about by using the current candidate branch compared to the current output branch;
6) selecting an uncertainty level corresponding to a maximum speedup ratio from all current candidate branches, taking the current candidate branch of the uncertainty level as a new current output branch of the uncertainty level, to obtain an updated current distribution scheme; updating the current candidate branch of the uncertainty level to obtain an updated candidate branch set; and
7) repeating steps 5) to 6) until all current candidate branches in the candidate branch set meet a set target requirement, and taking the current distribution scheme as a final distribution scheme of the multi-branch network.

7. The method of claim 4, wherein the model division scheme is determined by:
1) updating a network bandwidth by using an exponential moving average method with an expression as:
$$Band = ( 1 - α ) * Band + α * B\_runtime$$
wherein Band represents the network bandwidth, B_runtime represents a real-time network bandwidth, and a represents a hyperparameter, and 0≤a≤1;
2) determining an optimization objective of model division of the multi-branch network:
$$T = {\sum }_{m = 1} ( min {T}_{branch}^{m} ) * {p}_{m}$$
wherein T represents an average reasoning time of the multi-branch network, T_{branch}^{m} represents a reasoning time of an m^{th} branch, and Pₘ represents a probability that the m^{th} branch is selected;
3) determining the model division point of each branch to obtain the model division scheme of the multi-branch network;
wherein for any branch, the model division point is determined by:
3-1) establishing a directed acyclic graph corresponding to the branch;
taking any branch as an independent deep neural network (DNN) model, and establishing a directed acyclic graph G=(V, E) corresponding to the DNN model; wherein V represents a set of nodes in the graph G, and each of the nodes is a layer in the DNN model corresponding to the graph G; E represents a set of edges, indicating a set of links of the DNN model corresponding to the graph G, and each of the links reflects a flow direction of data;
taking a link lᵢⱼ=(aᵢ, aⱼ) to represent that an output of a node aᵢ is an input of a node aⱼ, and dᵢ to represent a size of output data of the node aᵢ, then a network transmission time of the link lᵢⱼ=(aᵢ, aⱼ) being
$${t}_{ij}^{net} = \frac{{d}_{i}}{Band} ;$$
dividing the set V into two disjoint subsets V_{device} and V_{edge}, wherein V_{device} represents a subset of nodes executed on the IoT device, and V_{edge} represents a subset of nodes executed on the server; taking L to represent a set of links between the two subsets, i.e., the model division point, a total delay of the cooperative reasoning is a sum of a total execution time T_{device}=Σ_{ν}_{ᵢ}_{∈V}_{_{device}}tᵢ^{device} of executing the subset V_{device} on the IoT device and a total execution time T_{edge}=Σ_{ν}_{ᵢ}_{∈V}_{_{edge}}tᵢ^{edge} of executing the subset V_{edge} on the server, wherein tᵢ^{device} represents an execution time of a layer corresponding to the node aᵢ on the IoT device, and tᵢ^{edge} represents an execution time of the layer corresponding to the node aᵢ on the server; and a sum of a total data transmission data of the model division point L is
$${T}_{net} = \frac{{\sum }_{{l}_{ij} ∈ L} {d}_{i}}{Band} ,$$
then:
$$min {T}_{branch}^{m} = {T}_{device} + {T}_{net} + {T}_{edge} ;$$
3-2) adding two virtual nodes d and e in the graph G; wherein d represents the IoT device, which is a source node; e represents an edge server node, which is a destination node; adding a new edge in the graph G, such that each edge in the graph corresponds to a delay, and the delay comprises a network transmission time, an execution time on the IoT device, and an execution time on an edge server; obtaining a new directed acyclic graph Ĝ after a construction is completed; and
3-3) finding a minimum secant between the source node d and the destination node e in the graph Ĝ, and taking the minimum secant as the model division point of the branch; taking the minimum secant as a boundary to allocate a node on the same side as the source node in the graph Ĝ to the IoT device, and allocate a node on the same side as the destination node to the server.

8. The method of claim 3, wherein the distribution scheme of the multi-branch network is determined by:
1) determining an uncertainty of each sample in a preset evaluation set by using the multi-branch network, and determining an uncertainty distribution of the evaluation set, the evaluation set comprising a plurality of samples and classification results corresponding to the plurality of samples;
2) equally dividing all samples in the evaluation set into M groups based on the uncertainty distribution of the evaluation set to obtain a division result of uncertainty levels, wherein M represents a total number of preset uncertainty levels;
3) determining an initial distribution scheme, a current output branch corresponding to samples of each uncertainty level in the evaluation set in the initial distribution scheme being the first branch of the multi-branch network;
4) taking a current candidate branch corresponding to each uncertainty level as a next branch of the current output branch;
5) determining a speedup ratio corresponding to the current candidate branch for each uncertainty level by using the evaluation set, the speedup ratio being a ratio of a prediction accuracy increase brought about by using the current candidate branch compared to the current output branch to a reasoning time increase brought about by using the current candidate branch compared to the current output branch;
6) selecting an uncertainty level corresponding to a maximum speedup ratio from all current candidate branches, taking the current candidate branch of the uncertainty level as a new current output branch of the uncertainty level, to obtain an updated current distribution scheme; updating the current candidate branch of the uncertainty level to obtain an updated candidate branch set; and
7) repeating steps 5) to 6) until all current candidate branches in the candidate branch set meet a set target requirement, and taking the current distribution scheme as a final distribution scheme of the multi-branch network.

9. The method of claim 6, wherein the model division scheme is determined by:
1) updating a network bandwidth by using an exponential moving average method with an expression as:
$$Band = ( 1 - α ) * Band + α * B\_runtime$$
wherein Band represents the network bandwidth, B_runtime represents a real-time network bandwidth, and a represents a hyperparameter, and 0≤a≤1;
2) determining an optimization objective of model division of the multi-branch network:
$$T = {\sum }_{m = 1} ( min {T}_{branch}^{m} ) * {p}_{m}$$
wherein T represents an average reasoning time of the multi-branch network, T_{branch}^{m} represents a reasoning time of an m^{th} branch, and Pₘ represents a probability that the m^{th} branch is selected;
3) determining the model division point of each branch to obtain the model division scheme of the multi-branch network;
wherein for any branch, the model division point is determined by:
3-1) establishing a directed acyclic graph corresponding to the branch;
taking any branch as an independent deep neural network (DNN) model, and establishing a directed acyclic graph G=(V, E) corresponding to the DNN model; wherein V represents a set of nodes in the graph G, and each of the nodes is a layer in the DNN model corresponding to the graph G; E represents a set of edges, indicating a set of links of the DNN model corresponding to the graph G, and each of the links reflects a flow direction of data;
taking a link lᵢⱼ=(aᵢ, aⱼ) to represent that an output of a node aᵢ is an input of a node aⱼ, and dᵢ to represent a size of output data of the node aᵢ, then a network transmission time of the link lᵢⱼ=(aᵢ, aⱼ) being
$${t}_{ij}^{net} = \frac{{d}_{i}}{Band} ;$$
dividing the set V into two disjoint subsets V_{device} and V_{edge}, wherein V_{device} represents a subset of nodes executed on the IoT device, and V_{edge} represents a subset of nodes executed on the server; taking L to represent a set of links between the two subsets, i.e., the model division point, a total delay of the cooperative reasoning is a sum of a total execution time T_{device}=Σ_{ν}_{ᵢ}_{∈V}_{_{device}}tᵢ^{device} of executing the subset V_{device} on the IoT device and a total execution time T_{edge}=Σ_{ν}_{ᵢ}_{∈V}_{_{edge}}tᵢ^{edge} of executing the subset V_{edge} on the server, edge wherein tᵢ^{device} represents an execution time of a layer corresponding to the node aᵢ on the IoT device, and tᵢ^{edge} represents an execution time of the layer corresponding to the node aᵢ on the server; and a sum of a total data transmission data of the model division point L is
$${T}_{net} = \frac{{\sum }_{{l}_{ij} ∈ L} {d}_{i}}{Band} ,$$
then:
$$min {T}_{branch}^{m} = {T}_{device} + {T}_{net} + {T}_{edge} ;$$
3-2) adding two virtual nodes d and e in the graph G; wherein d represents the IoT device, which is a source node; e represents an edge server node, which is a destination node; adding a new edge in the graph G, such that each edge in the graph corresponds to a delay, and the delay comprises a network transmission time, an execution time on the IoT device, and an execution time on an edge server; obtaining a new directed acyclic graph Ĝ after a construction is completed; and
3-3) finding a minimum secant between the source node d and the destination node e in the graph Ĝ, and taking the minimum secant as the model division point of the branch; taking the minimum secant as a boundary to allocate a node on the same side as the source node in the graph Ĝ to the IoT device, and allocate a node on the same side as the destination node to the server.

10. An electronic device, comprising:
at least one processor; and
a memory communicatively connected to the at least one processor and storing instructions executable by the at least one processor;
wherein the at least one processor is configured to perform the method according to claim 1.

11. The electronic device according to claim 10, wherein the at least one processor is configured to perform the method according to claim 2.

12. The electronic device according to claim 10, wherein the at least one processor is configured to perform the method according to claim 3.

13. The electronic device according to claim 11, wherein the at least one processor is configured to perform the method according to claim 5.

14. The electronic device according to claim 10, wherein the at least one processor is configured to perform the method according to claim 6.

15. The electronic device according to claim 10, wherein the at least one processor is configured to perform the method according to claim 7.

16. A non-transitory computer readable storage medium having stored therein computer instructions that, when executed by a processor, cause the processor to perform the method according to claim 1.

17. The non-transitory computer readable storage medium according to claim 16, wherein the computer instructions, when executed by the processor, cause the processor to perform the method according to claim 2.

18. The non-transitory computer readable storage medium according to claim 17, wherein the at least one processor is configured to perform the method according to claim 5.

19. The non-transitory computer readable storage medium according to claim 16, wherein the at least one processor is configured to perform the method according to claim 6.

20. The non-transitory computer readable storage medium according to claim 16, wherein the at least one processor is configured to perform the method according to claim 7.
